(19) United States
(12) Patent Application Publication
(10) Pub. No.: US 2011/0136715 A1
(43) Pub. Date: Jun. 9, 2011

(54) COLOR-CHANGING PRE-TREATMENT STAIN REMOVERS AND METHODS FOR FABRICATING THE SAME

(75) Inventors: Danielle SHAPIRO, Phoenix, AZ (US); Joan M. BERGSTROM, Phoenix, AZ (US)

(73) Assignee: THE DIAL CORPORATION, Scottsdale, AZ (US)

(21) Appl. No.: 12/632,586

(22) Filed: Dec. 7, 2009

(51) Int. Cl. C11D 3/40

(52) U.S. Cl. 510/100

(57) ABSTRACT

Color-changing pre-treatment stain removers and methods for fabricating them are provided. In one embodiment, a color-changing pre-treatment stain remover comprises a stain remover composition and a colorant that changes color upon contact with a stain on a textile within a time period that the stain is pre-treated by the stain remover composition. A method for fabricating a color-changing pre-treatment stain remover comprises forming a stain remover composition and adding a colorant to the stain remover composition. The colorant is adapted to change color upon contact with a stain on a textile within a time period that the stain is treated by the stain remover composition. The stain remover composition and the colorant are mixed until a homogeneous mixture is achieved.

### FIELD OF THE INVENTION

The present invention generally relates to textile cleaning compositions and methods for fabricating textile cleaning compositions, and more particularly relates to color-changing pre-treatment stain removers and methods for fabricating color-changing pre-treatment stain removers.

### BACKGROUND OF THE INVENTION

Pre-treatment stain removers typically are liquid, stick, or gel surfactant-containing compositions that are designed to remove, or ready for removal, a stain from a textile before and/or during a subsequent washing and rinsing cycle. While pre-treatment stain removers can be effective for treating stains for removal, they can be so only if provided sufficient time to act on the stain. However, it is often difficult for consumers to know how long to leave a pre-treatment stain remover on a stain for effective pre-treatment. While consumers desire the removal of stains, they also may not wish to lengthen the washing task, which, when using a conventional washing machine, typically can take from about 20 minutes to an hour or more to complete. An indicator that easily conveys to consumers when a sufficient time has elapsed for a stain remover to act on a stain would greatly assist consumers in the washing task.

Accordingly, it is desirable to provide a color-changing pre-treatment stain remover that changes color upon contact with a stain on a textile within a time period sufficient to pre-treat the stain. In addition, it is desirable to provide a method for fabricating such a color-changing pre-treatment stain remover. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Color-changing pre-treatment stain removers and methods for fabricating color-changing pre-treatment stain removers are provided. In accordance with an exemplary embodiment, a color-changing pre-treatment stain remover comprises a stain remover composition and a colorant that changes color upon contact with a stain on a textile within a time period that the stain is pre-treated by the stain remover composition.

In accordance with another exemplary embodiment, a method for fabricating a color-changing pre-treatment stain remover comprises forming a stain remover composition and adding a colorant to the stain remover composition. The colorant is adapted to change color upon contact with a stain on a textile within a time period that the stain is pre-treated by the stain remover composition. The stain remover composition and the colorant are mixed until a homogeneous mixture is achieved.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The various embodiments of the present invention relate to pre-treatment stain removers that change color upon contact with a stain for a time sufficient to pre-treat the stain. As used herein, to “change color” means to change color to the extent that the color change is detectable by the human eye. As used herein, to “pre-treat” a stain means to penetrate a stain with a liquid, foam, gel, or the like that loosens the stain from a textile and/or increases the rate of removal or the amount of removal of the stain during subsequent washing compared to the rate or amount of removal of the stain from the textile without pre-treatment. As used herein, the term “pre-treatment stain remover” refers to a liquid, foam, gel, stick, or the like that is applied directly to a stain on a textile and is permitted to remain in contact with the stain for a period of time sufficient to pre-treat the stain before the textile is washed and rinsed during a subsequent washing cycle, typically in an automated washing machine. The various embodiments of the color-changing pre-treatment stain remover contemplated herein comprise a colorant that changes color upon contact with a stain for a time sufficient to pre-treat the stain. In this regard, the color change of the pre-treatment stain remover, detectable by the eye of a user, serves as an indicator to the user that the stain has been sufficiently pre-treated.

In a preferred embodiment, the color-changing pre-treatment stain removers contemplated herein are foaming stain removers that are dispensed as foams and are formulated to pre-treat stains on textiles. Stain removers that are dispensed as foams provide consumers with the sensation that the stain is being actively “scrubbed” by the stain remover. However, the invention is not so limited and the stain removers also can be of liquid, non-foaming form.

In accordance with an exemplary embodiment of the present invention, the pre-treatment stain remover comprises a stain remover composition and a colorant that changes color upon contact with a stain. The colorant may take different time periods to change colors depending on the pH of the stain. The colorant changes color when in contact with a stain within a time period adequate for the stain remover composition to pre-treat the stain. Preferably, the stain remover is formulated to substantially pre-treat a stain within about 5 to about 10 minutes and the colorant changes color within about 5 to about 10 minutes of contact with the stain. The colorant may or may not enhance the pre-treatment of the stain by the stain remover composition. In a preferred embodiment, if dispensed on a clean textile, the colorant may not change color or may change color as detectable by the human eye only after an extended period of time beyond which a consumer would want to pre-treat a stain, such as, for example, about 1 hour. Colorants suitable for use in the pre-treatment stain removers contemplated herein include triphenylmethane dyes, such as Purple CC available from Milliken Chemical of Inman, S.C. In an exemplary embodiment, the pre-treatment stain removers contemplated herein comprise colorant in the amount of from about 0.05 to about 5 weight percent (wt %) of the pre-treatment stain remover.

The stain remover composition comprises a surfactant system that may comprise one or more anionic surfactants, nonionic surfactants, amphoteric surfactants, or combinations thereof. In an exemplary embodiment, the pre-treatment stain removers contemplated herein comprise a surfactant system in the amount of from about 5 to about 10 wt % of the color-changing pre-treatment stain remover. The surfactant system of the stain remover composition preferably includes a nonionic surfactant. Nonionic surfactants useful in the present invention include ethoxylated and/or propoxylated primary alcohols having 10 to 18 carbon atoms and on average from 2 to 10 moles of ethylene oxide (EO) and/or from 1 to 10 moles of propylene oxide (PO) per mole of alcohol. Further examples are alcohol ethoxylates containing linear radicals from alcohols of natural origin having 12 to 18 carbon atoms, e.g., from coconut, palm, tallow fatty or oleyl alcohol and on average from 2 to about 9 EO per mole of alcohol. Most useful as a nonionic surfactant in the present invention are the C₁₄-C₁₅ alcohol with an average of approximately 7 moles of ethylene oxide per mole of alcohol, such as Neodol 45-7, and the C₁₂-C₁₅ alcohol with an average of approximately 3 moles of ethylene oxide per mole of alcohol, such as Neodol 25-3, both available from Shell Chemicals of Houston, Tex. Most preferred for use in the surfactant system is a mixture of the C₁₄-C₁₅ alcohol ethoxylate-7EO and the C₁₂-C₁₅ alcohol ethoxylate-3EO. In an exemplary embodiment, the pre-treatment stain removers comprises from about 2 to about 6 wt %, preferably about 4 wt %, C₁₄-C₁₅ alcohol ethoxylate-7EO and from about 0.5 to about 2 wt %, preferably about 1 wt %, C₁₂-C₁₅ alcohol ethoxylate-3EO.

Anionic surfactants that are useful in the color-changing pre-treatment stain removers contemplated herein are alkyl ether sulfates, also known as alcohol ether sulfates. Alcohol ether sulfates are the sulfuric monoesters of the straight chain or branched alcohol ethoxylates and have the general formula R—(CH₂CH₂O)ₓ—SO₃M, where R—(CH₂CH₂O)ₓ— preferably comprises C₇-C₁₂ alcohol ethoxylated with from about 0.5 to about 9 mol of ethylene oxide (x=0.5 to 9 EO), such as C₁₂-C₁₈ alcohols containing from 0.5 to 9 EO, and where M is alkali metal or ammonium, alkyl ammonium, or alkanol ammonium counterion. Preferred alkyl ether sulfonates include sodium laureth sulfate with 2 moles of ethylene oxide. It is understood that when referring to alkyl ether sulfates, these substances are already salts (hence “sulfonate”), and most preferred and most readily available are the sodium alkyl ether sulfates (also referred to as NaAES). Commercially available alkyl ether sulfates include the CALFOAM® alcohol ether sulfates from Pilot Chemical, the EMAL®, LEVENOL® and LATEMAL® products from KAO Corporation of Japan, and the POLYSTEP® products from Stepan of Northfield, Ill. Alternatively, the alkyl ether sulfates for use in the pre-treatment stain removers may be prepared by sulfonation of alcohol ethoxylates (i.e., nonionic surfactants) if the commercial alkyl ether sulfate with the desired chain lengths and EO content are not easily found, but perhaps where the nonionic alcohol ethoxylate starting material may be. In one exemplary embodiment, the color-changing pre-treatment stain removers contemplated herein comprise from about 1.5 to about 4 wt % anionic surfactant. Other anionic surfactants, such as alkyl benzene sulfonates, may also be useful in the pre-treatment stain removers contemplated herein.

The stain remover composition further comprises one or more buffers that cause the color-changing pre-treatment stain removers to have an alkalinity in the range of from about pH 8 to about pH 10, preferably about pH 9. Buffers suitable for use in the color-changing pre-treatment stain removers include hydroxides such as sodium hydroxide (NaOH), ammonium hydroxide (NH₃OH), and potassium hydroxide (KOH), and carbonates such as sodium carbonate (Na₂CO₃), sodium bicarbonate (NaHCO₃), and the like. In a preferred embodiment, the color-changing pre-treatment stain removers contemplated herein comprise sodium hydroxide, ammonium hydroxide, sodium bicarbonate, or a combination thereof. In another preferred embodiment, the color-changing pre-treatment stain removers comprise one or more buffers in an amount of from about 0.1 to about 2 wt % of the color-changing pre-treatment stain remover.

The stain remover composition also may comprise other additives and processing aids. For example, in one embodiment, the stain remover composition comprises enzymes and enzyme stabilizers. Enzymes suitable for use in the stain remover compositions include amylase, protease, lipase, mannanase, cellusase, and the like. Suitable enzyme stabilizers include boric acid, calcium chloride, sodium chloride, propylene glycol, glycerine, glycol, monopropylene glycol, formats, and the like. In an exemplary embodiment, the color-changing pre-treatment stain removers contemplated herein include enzymes in the amount of from 0.01 to about 1 wt % of the color-changing pre-treatment stain remover. The pre-treatment stain removers may also comprise solvents, such as water, propylene glycol, glycerine, glycol, monopropylene glycol, and the like, and additives such as preservatives, fragrances, and the like. In addition, if a color-changing pre-treatment stain remover is to be dispensed as a foam, it also may comprise foaming and/or non-foaming processing aids.

In accordance with an exemplary embodiment of the present invention, a method for fabricating a color-changing pre-treatment stain remover comprises adding the ingredients of the color-changing pre-treatment stain remover in a desirable sequence and mixing the ingredients during and/or after the adding until a homogeneous composition is achieved. In a preferred embodiment, the method begins by combining a surfactant system and a solvent, such as water. The surfactant system/solvent combination can be mixed during the combining of the surfactant system and water and/or thereafter. In an optional embodiment, enzyme stabilizers are added to the surfactant system/solvent combination as mixing continues. Next, one or more buffers are added to adjust the pH of the combination. Preferably, buffers are added in kind and amount so that the combination achieves a pH of from about 8 to about 10. After the pH is properly adjusted, an additional solvent and/or enzyme stabilizer can be added. The colorant then is added to the combination. Any other additives such as fragrance, preservatives, and/or enzymes can also be added. Mixing can continue as the ingredients are added or can be stopped before addition of an ingredient and restarted after the addition.

The following are exemplary embodiments of color-changing pre-treatment stain removers contemplated herein, with each of the components set forth in weight percent of the total color-changing pre-treatment stain removers. The examples are provided for illustration purposes only and are not meant to limit the various embodiments of the color-changing pre-treatment stain removers in any way. As used in the examples, the surfactant system comprises C₁₄-C₁₅ alcohol ethoxylate-7EO in the amount of about 4.1 wt % of the color-changing pre-treatment stain remover, C₁₂-C₁₅ alcohol ethoxylate-3EO in the amount of about 1 wt % of the color-changing pre-treatment stain remover, and sodium laureth sulfate-2EO in the amount of about 2.7 wt % of the color-changing pre-treatment stain remover.

### Example 1

| Ingredient | Wt. % |
|---|---|
| Surfactant system | 5-10 |
| Boric Acid | 1-5 |
| CaCl | 1-5 |
| NaCl | 1-5 |
| Anti-foam processing aid | 0.1-1 |
| NaOH | 0.1-1 |
| Propylene Glycol | 1-5 |
| Colorant | 0.5-5 |
| Fragrance | 0.1-1 |
| Enzymes (Amylase, Protease & Lipase) | 0.1-1 |
| Preservative | 0.1-1% |
| Water | Balance |
| Total | 100% |

### Example 2

| Ingredient | Wt. % |
|---|---|
| Surfactant system | 5-10 |
| Boric Acid | 1-5 |
| CaCl | 1-5 |
| NaCl | 1-5 |
| Anti-foam processing aid | 0.1-1 |
| NaOH | 0.1-1 |
| NH₃OH | 0.1-1 |
| Propylene Glycol | 1-5 |
| Colorant | 0.5-5 |
| Fragrance | 0.1-1 |
| Enzymes (Amylase, Protease & Lipase) | 0.1-1 |
| Preservative | 0.1-1% |
| Water | Balance |
| Total | 100% |

### Example 3

| Ingredient | Wt. % |
|---|---|
| Surfactant system | 5-10 |
| Boric Acid | 1-5 |
| CaCl | 1-5 |
| NaCl | 1-5 |
| Anti-foam processing aid | 0.1-1 |
| NaOH | 0.1-1 |
| NaHCO₃ | 0.1-1 |
| Propylene Glycol | 1-5 |
| Colorant | 0.5-5 |
| Fragrance | 0.1-1 |
| Enzymes (Amylase, Protease & Lipase) | 0.1-1 |
| Preservative | 0.1-1% |
| Water | Balance |
| Total | 100% |

### Example 4

| Ingredient | Wt. % |
|---|---|
| Surfactant system | 5-10 |
| Boric Acid | 1-5 |
| CaCl | 1-5 |
| NaCl | 1-5 |
| Anti-foam processing aid | 0.1-1 |
| NH₃OH | 0.1-1 |
| Propylene Glycol | 1-5 |
| Colorant | 0.5-5 |
| Fragrance | 0.1-1 |
| Enzymes (Amylase, Protease & Lipase) | 0.1-1 |
| Preservative | 0.1-1% |
| Water | Balance |
| Total | 100% |

### Example 5

| Ingredient | Wt. % |
|---|---|
| Surfactant system | 5-10 |
| Boric Acid | 1-5 |
| CaCl | 1-5 |
| NaCl | 1-5 |
| Anti-foam processing aid | 0.1-1 |
| NH₃OH | 0.1-1 |
| NaHCO3 | 0.1-1 |
| Propylene Glycol | 1-5 |
| Colorant | 0.5-5 |
| Fragrance | 0.1-1 |
| Enzymes (Amylase, Protease & Lipase) | 0.1-1 |
| Preservative | 0.1-1% |
| Water | Balance |
| Total | 100% |

Accordingly, color-changing pre-treatment stain removers and methods for fabricating color-changing pre-treatment stain removers are provided herein. The various embodiments of the color-changing pre-treatment stain removers contemplated herein comprise a colorant that changes color upon contact with a stain for a time sufficient for a stain remover composition of the pre-treatment stain remover to pre-treat the stain. In this regard, the color change of the pre-treatment stain remover serves as an indicator that the stain has been sufficiently pre-treated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A color-changing pre-treatment stain remover comprising:
a stain remover composition; and
a colorant that changes color upon contact with a stain on a textile within a time period that the stain is pre-treated by the stain remover composition.

2. The color-changing pre-treatment stain remover of claim 1, wherein the stain remover composition is adapted to be dispensed as a foam.

3. The color-changing pre-treatment stain remover of claim 1, wherein the color-changing pre-treatment stain remover has a pH in the range of from about 8 to about 10.

4. The color-changing pre-treatment stain remover of claim 1, wherein the colorant is a triphenylmethane dye.

5. The color-changing pre-treatment stain remover of claim 1, further comprising the colorant in an amount of from about 0.05 to about 5 wt % of the color-changing pre-treatment stain remover.

6. The color-changing pre-treatment stain remover of claim 1, wherein the stain remover composition comprises a solvent, a surfactant system, and a buffer.

7. The color-changing pre-treatment stain remover of claim 6, wherein the surfactant system comprises an anionic surfactant and a nonionic surfactant.

8. The color-changing pre-treatment stain remover of claim 7, wherein the surfactant system comprises a mixture of C₁₄-C₁₅ alcohol ethoxylate-7EO and C₁₂-C₁₅ alcohol ethoxylate-3EO.

9. The color-changing pre-treatment stain remover of claim 7, wherein the anionic surfactant is an alcohol ether sulfate.

10. The color-changing pre-treatment stain remover of claim 6, wherein the buffer comprises sodium hydroxide, ammonium hydroxide, potassium hydroxide, sodium carbonate, sodium bicarbonate, or mixtures thereof.

11. The color-changing pre-treatment stain remover of claim 10, wherein the buffer comprises a mixture of sodium hydroxide, ammonium hydroxide, and sodium bicarbonate.

12. The color-changing pre-treatment stain remover of claim 6, further comprising the buffer in an amount of from about 0.1 to about 2 wt % of the color-changing pre-treatment stain remover.

13. The color-changing pre-treatment stain remover of claim 6, wherein the solvent comprises water, propylene glycol, glycerine, glycol, monopropylene glycol, or combinations thereof.

14. The color-changing pre-treatment stain remover of claim of claim 1, further comprising an enzyme and an enzyme stabilizer.

15. A method for fabricating a color-changing pre-treatment stain remover, the method comprising the steps of:
forming a stain remover composition;
adding a colorant to the stain remover composition, wherein the colorant is adapted to change color upon contact with a stain on a textile within a time period that the stain is pre-treated by the stain remover composition; and
mixing the stain remover composition and the colorant until a homogeneous mixture is achieved.

16. The method of claim 15, wherein the step of forming a stain remover composition comprises forming the stain remover composition so that it has a pH in the range of from about 8 to about 10.

17. The method of claim 15, wherein the step of adding a colorant comprises adding a triphenylmethane dye.

18. The method of claim 15, wherein the step of adding a colorant comprises adding the colorant such that the colorant is present in the color-changing pre-treatment stain remover in an amount of from about 0.05 to about 5 wt % of the color-changing pre-treatment stain remover.

19. The method of claim 15, wherein the step of forming a stain remover composition comprises combining a surfactant system, a buffer, and a solvent.

20. The method of claim 19, wherein the step of combining comprises combining the surfactant system, the solvent, and the buffer comprising sodium hydroxide, ammonium hydroxide, potassium hydroxide, sodium carbonate, sodium bicarbonate, or mixtures thereof.
